(19) United States
(12) Patent Application Publication
(10) Pub. No.: US 2014/0119589 A1
(43) Pub. Date: May 1, 2014

(54) EARBUD ATTACHMENT

(71) Applicants: Helmut Wyzisk, Orlando, FL (US); Jeffrey Becker, New York, NY (US)

(72) Inventors: Helmut Wyzisk, Orlando, FL (US); Jeffrey Becker, New York, NY (US)

(21) Appl. No.: 14/065,396

(22) Filed: Oct. 28, 2013

Related U.S. Application Data
(60) Provisional application No. 61/719,021, filed on Oct. 26, 2012.

(51) Int. Cl. H04R 1/10

(52) U.S. Cl. CPC H04R 1/105
USPC 381/380

(57) ABSTRACT

A circular in-ear headphone or earbud attachment can be attached to in-ear headphones or earbuds to provide traction and outward pressure to the ear of a user in order to secure an earbud in place and increase the quality of the fit. Additionally, the attachment can favorably increase the sound experience of the wearer.

### CROSS-REFERENCE TO RELATED APPLICATION

This application claims the benefit of U.S. Provisional Application No. 61/719,021 filed Oct. 26, 2012, titled EARBUD ATTACHMENT

### FIELD

The present invention relates to an attachment for circular in-ear headphones or earbuds that can be used to provide a more favorable sound experience and a more secure fit for users, particularly users who are engaging in active movement.

### BACKGROUND

Currently, many individuals who use headphones or earbuds while on-the-go use in-ear, circular earbuds. The earbuds that users wear are commonly provided with the device that the individual is using, such as a phone or MP3 player. However, earbuds can be uncomfortable to use. Additionally, they can be ill-fitting or loose in the user's ear. An attachment that increases comfort and fit for earbuds is needed.

### SUMMARY OF THE INVENTION

The present disclosure relates to an attachment for use with circular earbuds. The attachment provides traction and outward pressure to the ear of a user, which helps to secure an earbud in place. This provides a more favorable sound experience and a more secure fit, allowing a user to engage in movement such as exercise.

Reference is made throughout the present disclosure to certain aspects of the earbud attachment described herein. Such references to aspects of the presently described earbud attachment do not limit the scope of the disclosure. Additionally, any examples set forth in this disclosure are not intended to be limiting and merely set forth some of the many possible embodiments for the disclosed earbud attachment. It is to be understood that the phraseology and terminology used herein are for the purpose of description and should not be regarded as limiting.

### BRIEF DESCRIPTION OF THE DRAWINGS

FIG. 1 is a side view of one embodiment of the earbud attachment.

FIG. 2 is an isometric side angle view of one embodiment of the earbud attachment.

FIG. 3 is a bottom view of the attachment tire or elastic loop of one embodiment of the earbud attachment.

FIG. 4 is a top view of one embodiment of the earbud attachment.

FIG. 5 shows one embodiment of the earbud attachment in use with an earbud.

FIG. 6 is a side view of one embodiment of the earbud attachment with a cutout in the elastic loop allowing sound to escape from a forward facing speaker.

FIG. 7 is a front view of one embodiment of the earbud attachment with a cutout in the elastic loop allowing sound to escape from a forward facing speaker.

FIG. 8 is an isometric side angle view of one embodiment of the earbud attachment with a cutout in the elastic loop allowing sound to escape from a forward facing speaker.

FIG. 9 is a bottom view of one embodiment of the earbud attachment with a cutout in the elastic loop allowing sound to escape from a forward facing speaker.

### DETAILED DESCRIPTION

The present disclosure relates to an attachment for use with circular earbuds. Various embodiments of the earbud attachment will be described in detail with reference to the drawings, wherein like reference numerals represent like parts and assemblies throughout the several views. Reference to various embodiments does not limit the scope of the earbud attachment disclosed herein. Additionally, any examples set forth in this specification are not intended to be limiting and merely set forth some of the many possible embodiments for the earbud attachment. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

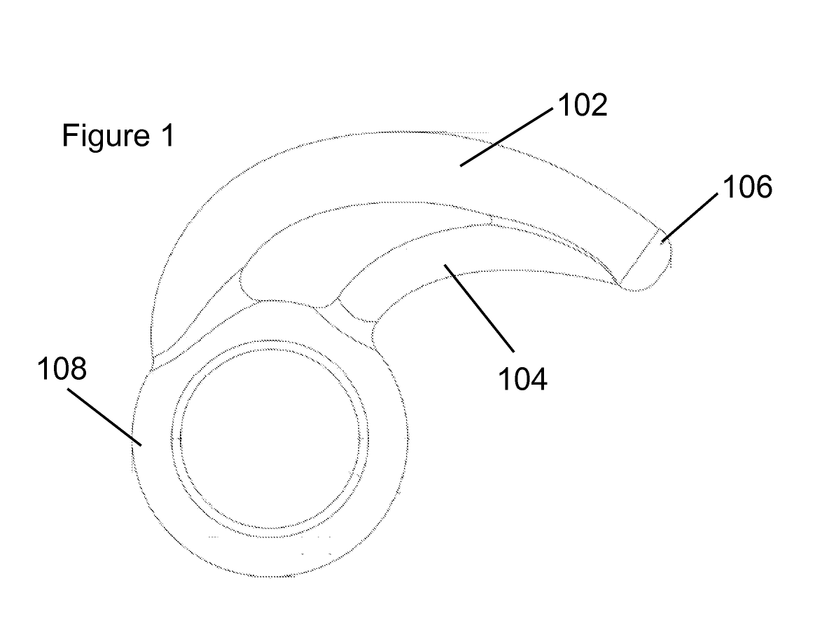

As illustrated in FIG. 1, one embodiment of the presently disclosed earbud attachment can be used with circular earbuds. The earbud attachment may be made of a durable, food-safe, water-resistant silicone to allow for maximum durability and resistance to wear. The water-resistant quality of the earbud attachment helps to maintain its hold in a perspiring ear, whereas a standalone earbud has a potential to slip or slide out of a user's ear, especially when the user is in motion (for example, engaged in exercise).

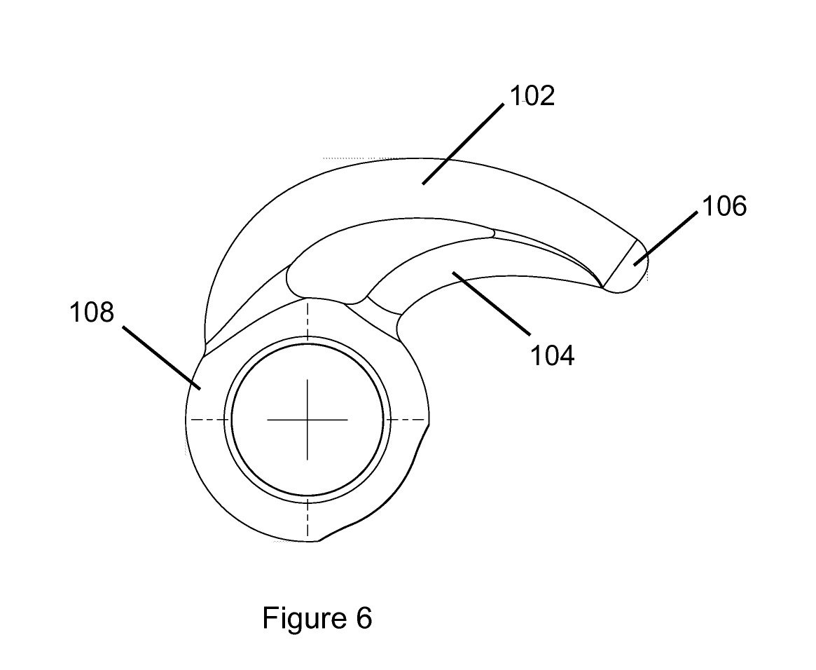

In the preferred embodiment, the earbud attachment is an injection-molded product made of liquid silicone rubber, a high purity platinum-cured silicone with a low compression set, great stability and the ability to resist extreme hot and cold temperatures. In the preferred embodiment, the silicone is in a range of 30-50 shore hardness. In one embodiment, due to the thermosetting nature of the material, liquid silicone injection molding may require special treatment, such as intensive distributive mixing, while maintaining the material at a low temperature before it is pushed into a heated cavity and vulcanized. The earbud attachment could be made of other flexible/semi-rigid materials, such as wood, metal or plastic. The materials used for the earbud attachment may be of any color or print. In an alternative embodiment, as illustrated in FIG. 6 and described further hereinafter, the presently disclosed earbud attachment can be used with earbuds with forward facing speakers.

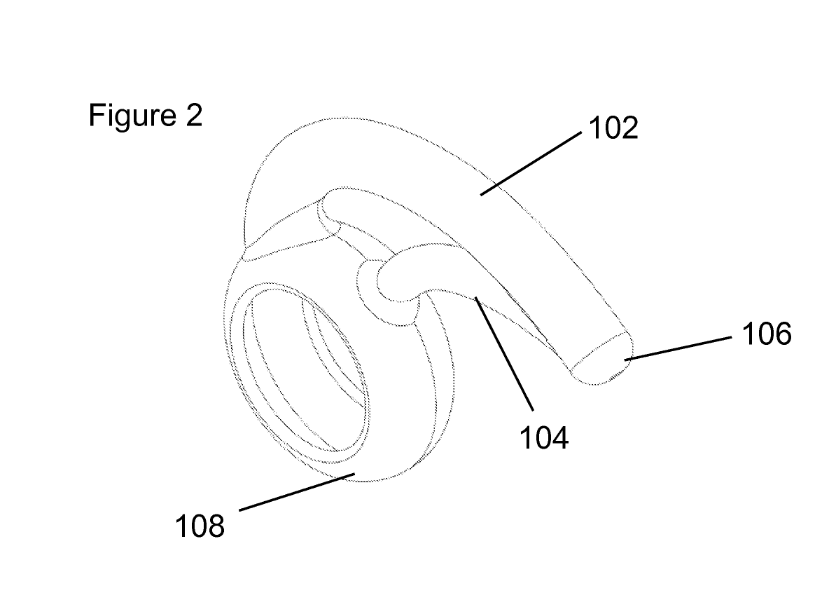

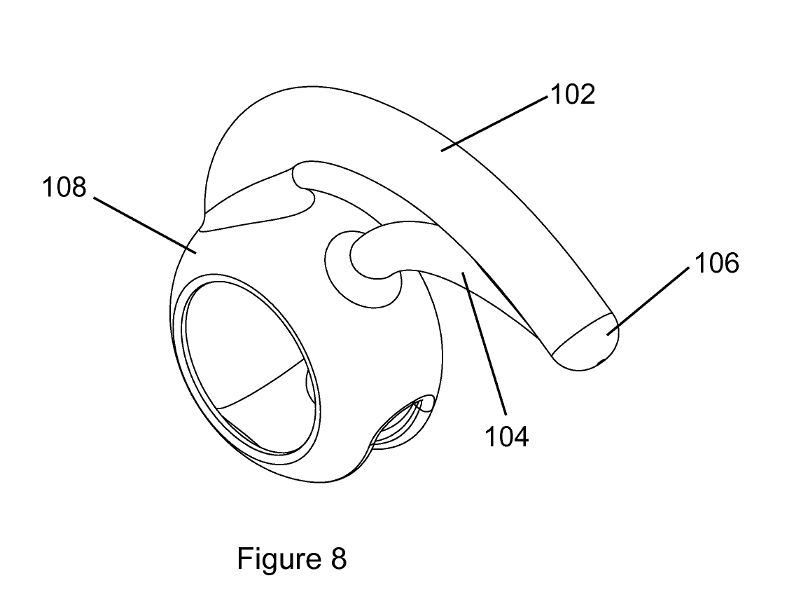

As illustrated in FIGS. 2 and 8, the earbud attachment has a shark fin shape made of flexible silicone that is designed to curve and bend with, and fit comfortably within, the ear of a user. The “fin” portion of the earbud attachment includes a top arm 102, a bottom arm 104, and a rounded tip 106. The shark fin design of the earbud attachment applies traction to a portion of a user's ear and outward pressure to other portions, for example, the antihelix and concha, two areas that commonly leave a standalone earbud vulnerable to feeling loose and/or falling out of a user's ear. The shape and design of the earbud attachment makes the attachment comfortable for everyday use and reliable enough for intense activity.

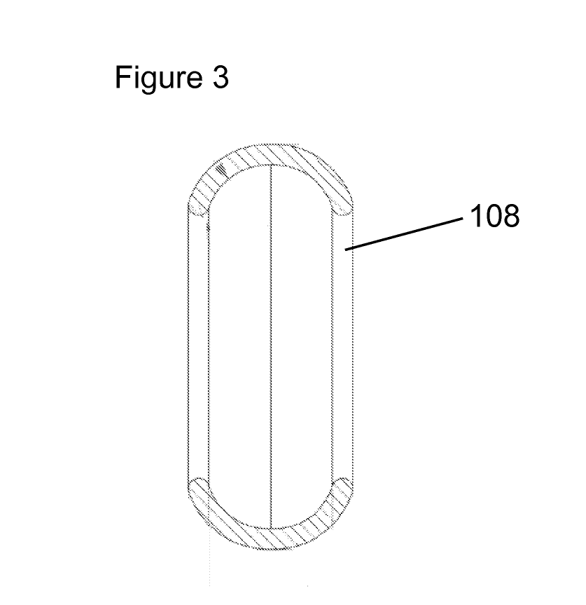

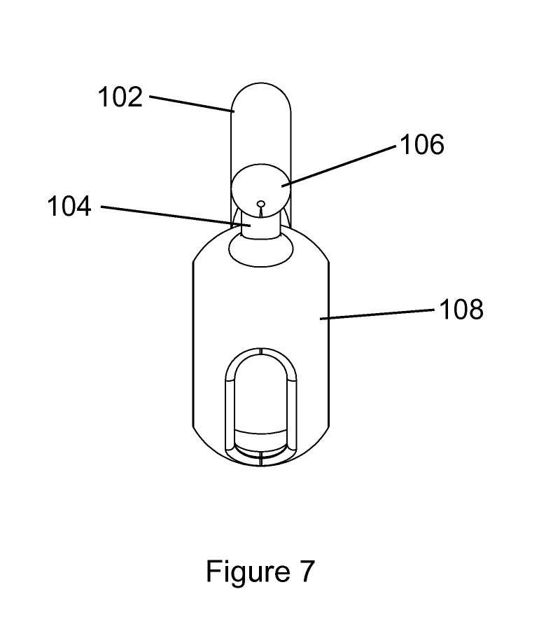

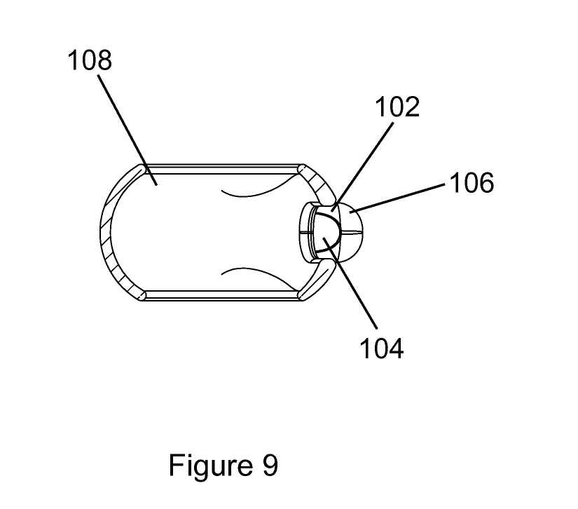

Referring again to FIGS. 1 and 6, the earbud attachment further includes an attachment tire or elastic loop 108 that fits snugly around the circumference of an earbud. The attachment tire 108 is designed with a centered hole that can stretch and hold a firm grip on the earbud, allowing it to stay attached through wear and storage. In one embodiment, as illustrated in FIG. 1, the centered hole also allows sound to be released from an earbud speaker. In another embodiment, an additional hole exists in the attachment tire 108 to allow sound to be released from a forward facing speaker, as illustrated in FIG. 7. In one embodiment, the additional hole in the attachment tire 108 can be an elongated oval. A bottom view of the attachment tire 108 without the additional hole is shown in FIG. 3. A bottom view of the attachment tire 108 with the additional hole is shown in FIG. 9.

The attachment tire 108 has a universal fit that is stretchable to attach to any earbud, and can be used to increase comfort, security and sound quality of the earbud. Companies such as JVC, Sony, Apple and others offer circular earbuds that can be used with the earbud attachment. One example of earbuds that may be used with the earbud attachment with the additional sound hole shown in FIG. 9 is the “EarPod” offered by Apple, which features a forward facing speaker.

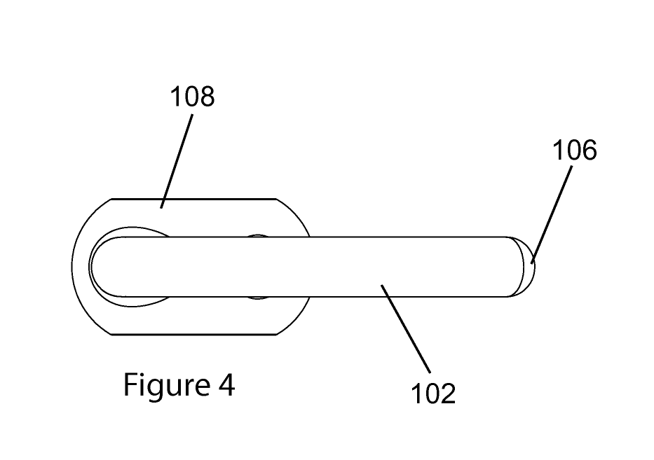

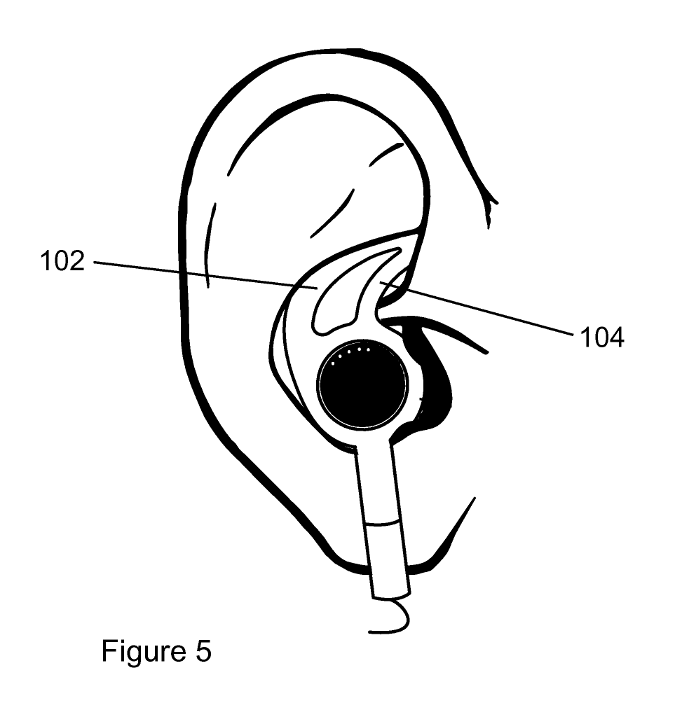

As illustrated in FIG. 5, the attachment tire 108 fits around the circular earbud and sits in the ear of the user, securing the earbud in place and creating an improved fit. The fin also sits in the ear of the user, applying pressure to the antihelix and concha to provide a more secure feeling than with standalone earbuds. The presently disclosed earbud attachment may come in many sizes and dimensions to fit into the ears of a variety of users. As illustrated by FIGS. 4 and 7, the tire attachment 108 may be slightly wider than the fin portion of the earbud attachment. The earbud attachment can be used interchangeably with a user's left ear and a user's right ear.

For a better understanding of the present disclosure, its advantages, and the specified objects attained by its uses, reference should be made to the accompanying drawings and descriptive matter in which there are illustrated exemplary embodiments of the present disclosure. The various embodiments described above are provided by way of illustration only and should not be construed to limit the disclosure. Those skilled in the art will readily recognize various modifications and changes that may be made without following the example embodiments and applications illustrated and described herein and without departing from the true spirit and scope of the disclosed earbud attachment.

1. A flexible earbud attachment for placement in an ear, comprising:
an elastic loop that fits around the circumference of a circular earbud with a centered hole for release of sound from the earbud; and
a fin-shaped projection attached to an external surface of the elastic loop and formed to apply traction to a portion of a user's ear and outward pressure to another portion of the user's ear.

2. The earbud attachment of claim 1, wherein the earbud attachment is made of a high purity, platinum-cured silicone.

3. The earbud attachment of claim 2, wherein the silicone is in a range of 30-50 shore hardness.

4. The earbud attachment of claim 2, wherein the earbud attachment has an additional, forward facing hole in the elastic loop to permit sound to be released from a forward facing earbud speaker.
